(19) United States
(12) Patent Application Publication
(10) Pub. No.: US 2007/0162895 A1
(43) Pub. Date: Jul. 12, 2007

(54) Mechanism and method for two level adaptive trace prediction

(75) Inventors: Erik R. Altman, Danbury, CT (US); Michael Karl Gschwind, Chappaqua, NY (US); Jude A. Rivers, Cortlandt Manor, NY (US); Sumedh W. Sathaye, Cary, NC (US); John-David Wellman, Hopewell Junction, NY (US); Victor Zyuban, Yorktown Heights, NY (US)

Correspondence Address: Frank Chau, Esq.;F. CHAU & ASSOCIATES, LLC, 130 Woodbury Road, Woodbury, NY, 11797, US

(73) Assignee: International Business Machines Corporation, Armonk, NY (US)

(21) Appl. No.: 11/329,319

(22) Filed: Jan. 10, 2006

(51) Int. Cl. G06F 9/44

(52) U.S. Cl. 717/128

(57) ABSTRACT

A trace cache system is provided comprising a trace start address cache for storing trace start addresses with successor trace start addresses, a trace cache for storing traces of instructions executed, a trace history table (THT) for storing trace numbers in rows, a branch history shift register (BHSR) or a trace history shift register (THSR) that stores histories of branches or traces executed, respectively, a THT row selector for selecting a trace number row from the THT, the selection derived from a combination of a trace start address and history information from the BHSR or the THSR, and a trace number selector for selecting a trace number from the selected trace number row and for outputting the selected trace number as a predicted trace number.

### BACKGROUND OF THE INVENTION

1. Field of the Invention

The present invention relates to computer processor pipeline management, and more particularly, to a mechanism and method to predict between multiple traces beginning at a particular instruction address.

2. Description of the Related Art

In a typical computer processor it is increasingly beneficial to fetch instructions quickly to keep the processor pipeline(s) supplied as processor frequencies escalate. One approach that has been proposed is the use of trace caches.

A trace cache contains instruction traces (traces), which are long sequences of instructions that have previously been observed to execute in sequence and are placed contiguously in the trace cache to allow efficient and speedy fetching of instructions when the trace executes subsequently. Traces are typically 4 to 32 instructions in length and generally contain multiple branch instructions. “Path Prediction for High Issue-Rate Processors”, Kishore Menezes, Sumedh Sathaye and Thomas M. Conte, PACT'97, pp. 178-188, November 1997, proposes allowing multiple traces starting from a single address. However, there are significant limitations in performance with their proposal, in particular the accuracy with which traces are predicted. The Menezes, et al, article considers a two level adaptive approach. However, the proposed approach requires a number of bits that increases exponentially with the number of branches in a trace.

For a trace to execute to completion, each branch must take the path that was taken when the trace was created. That is, conditional branches must fall through if the branch fell through when the trace was created and must go to the branch target address if the branch went to the branch target address when the trace was created. For indirect (register) branches, the branch target address must be the same as when the trace was created. This requirement that subsequent executions of the trace must have branches that behave in the same way as when the trace was created is a major source of inefficiency in trace caches. If a branch does not behave the same way, the trace must exit early before all of the instructions contained within it are put in the pipeline. Such interruptions reduce the efficiency of the processor and make it harder to keep the rest of the pipeline(s) fed with instructions. Redirecting instruction fetch to start from a new trace takes time and generally results in bubbles (gaps) in the rest of the pipeline(s). This redirection results in at least two effects. Instructions from the end of the trace that were expected to be used are wasted and must be discarded and instruction address registers must reset to the start of a new trace beginning at the point where the trace exited early.

FIG. 1 illustrates a conventional multipath trace cache. Referring to FIG. 1, in this illustrative example the traces contain five instructions. There may be two traces or paths, Path 1 and Path 2, that have been observed to execute from an instruction at address A and these two traces can be stored in a trace cache. If an instruction at address C is a branch instruction, the two paths have been observed to result from the branch instruction at address C. One path is where the branch has fallen through and a next sequential instruction at address D is executed followed by an instruction at address E. Alternatively, the branch instruction at address C may have resulted in program execution continuing to an instruction at address M followed by an instruction at address N. The next time the instruction at address A is executed, the history of executions from the instruction at address A is to follow either Path 1 or Path 2. A prediction mechanism is assigned the task of determining which of the paths or traces is most likely to execute based on their histories of execution.

The start of a successor trace can often be predicted once its predecessor begins execution. Early prediction allows the processor time to prepare for fetching the successor trace while the instructions from the current trace are fetched. However, if the trace exits early, the fetching of the successor trace is for naught and may even delay the fetching of the correct trace starting from the early exit point.

In allowing multiple traces starting from a single address, there are significant limitations in performance, in particular, the reduction of accuracy with which traces are predicted. With a single level of adaptive trace prediction, a saturating counter is maintained for each trace beginning at a particular address. The counter for a trace is incremented up to a maximum value when that trace executes and is decremented to a minimum value when one of the other traces with instructions beginning at the same address executes. Some of the prior art proposes a two level adaptive approach requiring a number of bits that increases exponentially with the number of branches in a trace.

Experience with branch prediction, as opposed to and as distinct from trace prediction, has shown that two level adaptive predictors have a significantly higher prediction accuracy than single level branch predictors. Other prior work on two level adaptive predictors for branches, multiple branches, or traces also have storage requirements that increase with the number of branches being predicted. Previous works base their predictions on saturating counter values, and the number of such counters generally increases exponentially with the number of branches in a trace.

### SUMMARY OF THE INVENTION

According to one exemplary embodiment of the present invention, a trace cache system is provided comprising a trace start address (TSA) cache for storing TSAs with successor TSAs, a trace cache for storing traces of instructions executed, a trace history table (THT) for storing trace numbers (TN) in rows, a branch history shift register (BHSR) or a trace history shift register (THSR) that stores histories of branches or traces executed, respectively, a THT row selector for selecting a trace number row from the THT, the selection derived from a combination of a TSA and history information from the BHSR or the THSR, and a trace number selector for selecting a trace number from the selected trace number row and for outputting the selected trace number as a predicted trace number.

According to another exemplary embodiment of the present invention, a method of trace prediction for a multipath trace cache system is provided comprising the steps of selecting a trace number row from a trace history table (THT), the selection derived from a combination of a TSA and history information from a branch history shift register (BHSR) or a trace history shift register (THSR), selecting a trace number from the selected trace number row, and outputting the selected trace number as a predicted trace number.

### BRIEF DESCRIPTION OF THE DRAWINGS

Exemplary embodiments of the invention are described with reference to the accompanying drawings, of which:

FIG. 1 illustrates a conventional multipath trace cache;

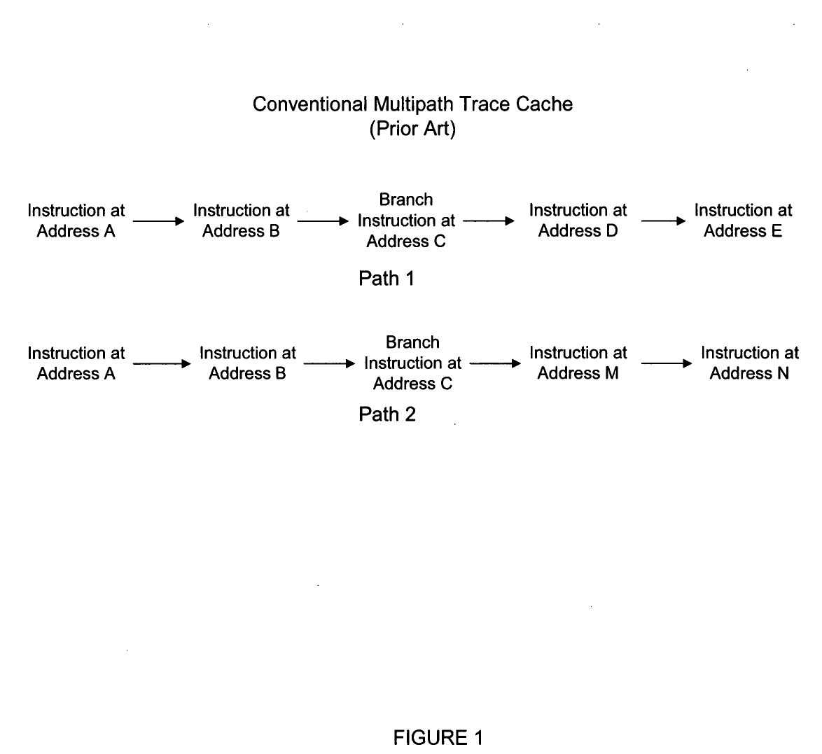

FIG. 2 is a block diagram of a multipath trace cache system using trace numbers;

FIG. 3 is a block diagram of a trace predictor structure according to an exemplary embodiment of the present invention;

FIG. 4 illustrates creating new traces according to an exemplary embodiment of the present invention;

FIG. 5 illustrates a trace history table (THT) according to an exemplary embodiment of the present invention; and

FIG. 6 is a block diagram of a trace history table update structure according to an exemplary embodiment of the present invention.

### DETAILED DESCRIPTION OF EXEMPLARY EMBODIMENTS

An exemplary embodiment of the present invention allows multiple traces to exist beginning at a particular instruction address and chooses or predicts among them. To enable prediction, the system includes three caches. There is a trace start address cache for providing TSAs, a first auxiliary cache for providing sequences of branch target addresses and a second auxiliary cache for providing sequences of correct or actual branch target addresses. There is also a trace history table (THT) where the entries are histories of traces executed.

The amount of trace history required is independent of the number of branches in the trace. The number of bits necessary to specify a trace is independent of the number of branches in a trace.

An exemplary embodiment of the present invention tracks predictions for multiple trace starting addresses and uses a two-level adaptive technique for predicting traces. With the multiple trace scheme, only one of the traces beginning at an instruction address need be correct in order for all of the instructions in a trace to be used, with no early exit. There are several options for making this selection.

The trace cache is addressed by a pair of numbers A and T. The values A and T used to address a cache are split into two parts, which are the tag and the set (congruence class). The k bits of T can be split between the tag and the set with the precise bits used for each determined to optimize system performance. If all bits of T are contained in the tag, then all traces beginning at a particular address A map to the same set. Consequently, the associativity of the cache must be at least 2^{k}. The structure and operation of caches is known and used in the prior art and they are used in a similar fashion in the present invention without additional description.

Once one or more traces exist beginning at an instruction address A, the processor must choose which trace to execute when execution reaches, or is predicted to reach address A. The history of traces executed is examined to predict which trace will execute next.

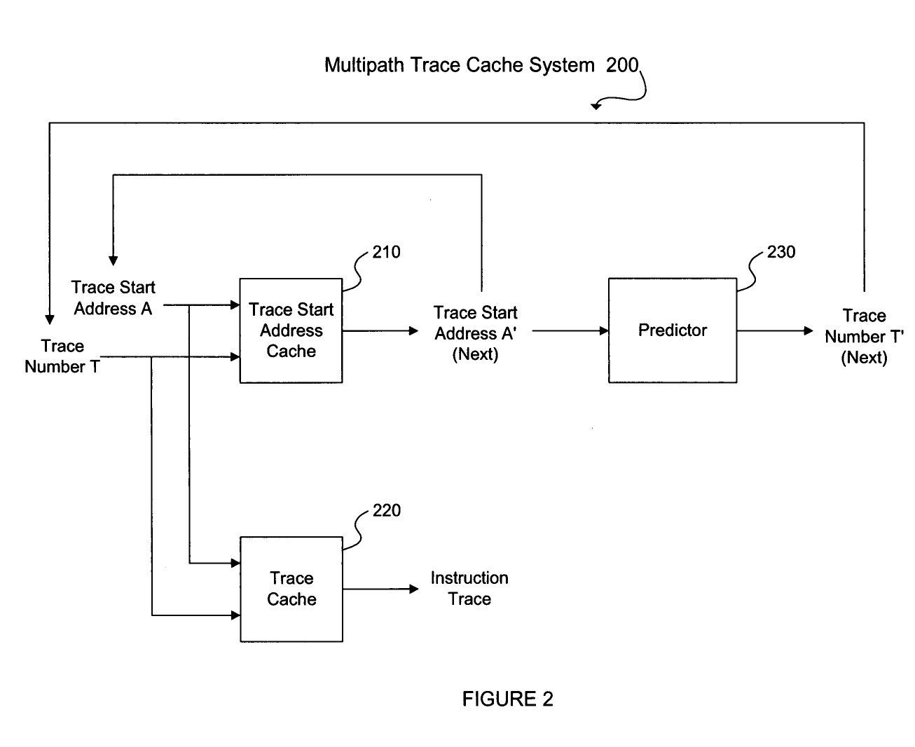

FIG. 2 is a block diagram of a multipath trace cache system using trace numbers. A trace cache 220 contains instruction traces (traces), which are long sequences of instructions that have previously been observed to execute in sequence and are placed contiguously in the trace cache 220 to allow efficient and speedy fetching of these instructions when this trace executes subsequently. Such sequences are typically 4 to 32 instructions in length and generally contain multiple branch instructions. “Path Prediction for High Issue-Rate Processors”, Kishore Menezes, Sumedh Sathaye and Thomas M. Conte, PACT'97, pp. 178-188, November 1997, proposes allowing multiple traces starting from a single address. However, there are significant limitations in performance, in particular the accuracy with which traces are predicted. The Menezes, et al, article considers a two level adaptive approach. However, the proposed approach requires a number of bits that increases exponentially with the number of branches in a trace.

A trace start address cache 210 can be used to provide the start address of a successor trace TSA′. This information can be used in a predictor 230 to choose the successor trace number TN′ of which one of multiple traces beginning at the successor trace start address TSA′ is most likely to execute to completion based on a history of branch results of branches that may be contained within the successor traces.

For a trace to execute to completion, each branch must take the path that was taken when the trace was created. That is, conditional branches must fall through if the branch fell through when the trace was created and must go to the branch target address if the branch went to the branch target address when the trace was created. For indirect (register) branches, the branch target address must be the same as when the trace was created. This requirement that subsequent executions of the trace must have branches that behave in the same way as when the trace was created is a major source of inefficiency in trace caches 220. If a branch does not behave the same way, the trace must exit early before all of the instructions contained within it are put in the pipeline. Such interruptions reduce the efficiency of the processor and make it harder to keep the rest of the pipeline(s) fed with instructions. Redirecting instruction fetch to start from a new trace takes time and generally results in bubbles (gaps) in the rest of the pipeline(s). This redirection results in at least two effects. Instructions from the end of the trace that were expected to be used are wasted and must be discarded and instruction address registers must reset to the start of a new trace beginning at the point where the trace exited early.

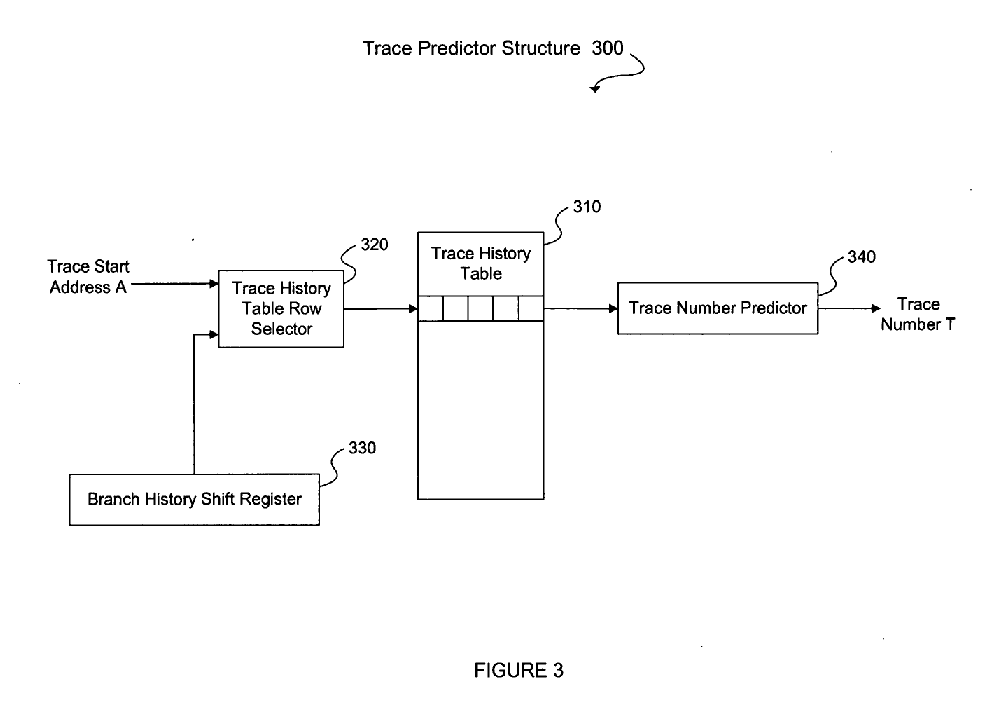

FIG. 3 is a block diagram illustrating a trace predictor structure according to an exemplary embodiment of the present invention. The trace predictor structure 300 includes a trace history table (THT) 310, a THT row selector 320, a branch history shift register (BHSR) 330 and a trace number predictor 340. The trace predictor structure 300 takes as an input a TSA and provides a predicted trace number TN′??. The TSA is typically the memory address of the next instruction to be fetched by the computer processor for entry into the processor's pipeline. The predicted trace number TN is typically used by a multipath trace cache system along with the next trace start address for indexing a next trace start address cache 210 to retrieve the next trace start address and the trace cache 220 to retrieve the trace.

In the trace predictor structure 300 the trace start address is combined with the BHSR data using an algorithm such as GSHARE or GAS to select a row of the last N trace numbers T contained in the THT 310 corresponding to the trace start address and the branch history. In the GSHARE algorithm, the row to be selected is the trace start address exclusive ORed with the BHSR. In the GAS algorithm, the row to be selected is the trace start address concatenated with the BHSR. For efficient implementation, a subset of bits of the trace start address may be used.
GSHARE: Row=Trace Start Address xor BHSR
GAS: Row=Trace Start Address∥BHSR, where ∥ denotes concatenation

For example, if the trace start address is 0011 0100 0010 1101, where a subset of only the high order 8 bits of the trace start address are used, and the BHSR is 1011 0010, then the row selected using GSHARE is 0011 0100 xor 1011 0010=1000 0110 and the row selected using GAS is 0011 01001∥1011 0010=0011 0100 1011 0010.

The choice of using a GSHARE, GAS or other algorithm is left to the system designer for the optimization of the trace prediction scheme of the computer system. BHSRs are used in conventional branch prediction systems and are used in a similar fashion herein without additional description.

Once the appropriate row of the THT 310 is accessed, the trace number predictor 340 selects a trace number T based on one of several algorithms also to be selected by the system designer to optimize the trace prediction scheme.

In one such algorithm the most recent of the most frequently occurring trace numbers T among the last N trace numbers T for the row selected in the THT 310 is selected for the predicted trace number T. In another such algorithm the most recently occurring trace number among the last N trace numbers for the row selected in the THT 310 to occur a predetermined number of times is selected for the predicted trace number. If no trace number occurs at least the predetermined number of times, then the most recent of the most frequently occurring trace numbers among the last N trace numbers for the row selected in the THT 310 is selected for the predicted trace number T.

In another embodiment (not shown) a trace history shift register is used where its information is combined with the trace start address to determine the appropriate row of the THT to be selected.

The trace predictor structure 300 also decides when a new trace should be created starting at a particular trace start address. Up to 2^{k} traces beginning at a particular instruction address can exist. The trace numbers at a particular address can thus be represented with k bits and can have values in the range 0 to 2^{k}−1. Thus a particular trace is identified by a pair of values which are the trace start address A of the first instruction of the trace and the trace number T in the range 0 to 2^{k}−1.

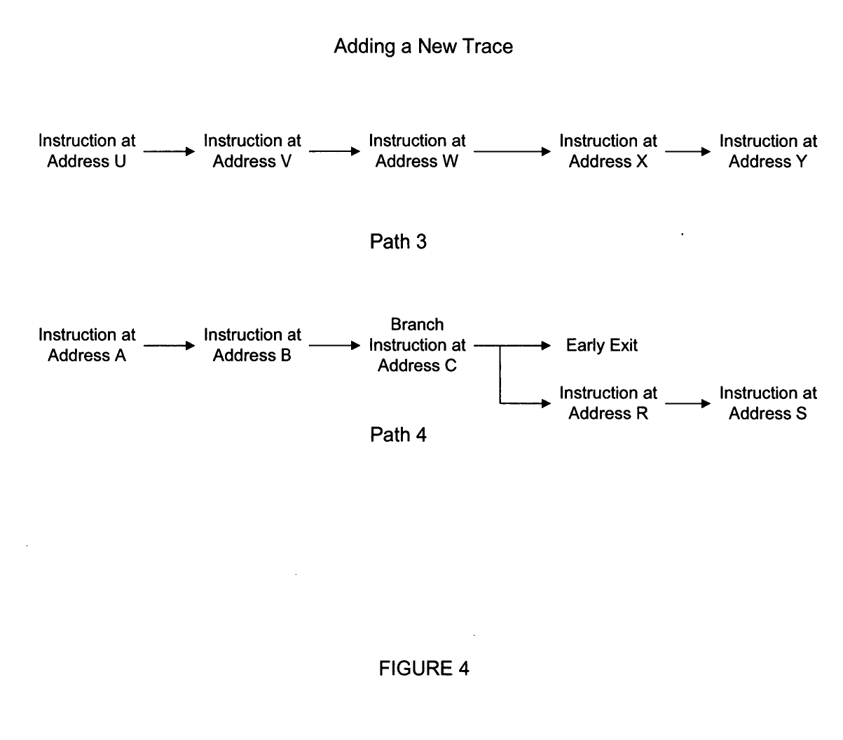

FIG. 4 illustrates creating new traces according to an exemplary embodiment of the present invention. Referring to FIG. 4, in this illustrative example the traces contain five instructions. There are several conditions under which a new trace can be created where any or all of these conditions can be implemented. There can be other conditions specified by the system designer for implementing trace creation. The following are some exemplary conditions.

A first exemplary condition for trace creation is where a trace is executed and no trace exists starting at that trace's start address. A second exemplary condition for trace creation is where a trace is executed and traces exist in the trace cache starting at that trace's starting address but none of them follow the entire trace path. A third exemplary condition for trace creation is where a trace is executed, traces exist in the trace cache starting at that trace's starting address but none of them follow the entire trace path and there are also no traces starting at the differing points in the trace path.

As examples of the previous three exemplary conditions, consider a trace cache system using a trace cache that contains five instruction addresses for each trace. There can be an execution of a sequence of instructions located at addresses U, V, W, X and Y Path 3 where there are no traces starting at address U in the trace cache. A trace=U, V, W, X, Y Path 3 (trace start address U, trace number 0) can be created according to the first exemplary condition. There can be an execution of a sequence of instructions located at addresses A, B, C, R and S Path 4 where there are only two traces existing in the trace cache starting at address A, which are Path 1=A, B, C, D, E (trace start address A, trace number 0) and Path 2=A, B, C, M, N (trace start address A, trace number 1). A trace=A, B, C, R, S Path 4 (trace start address A, trace number 2) can be created according to the second exemplary condition because of the branch instruction at address C where no trace exists in the trace cache starting at address A that goes to an instruction at address R after the branch instruction at address C. Also, there can be an execution of a sequence of instructions located at addresses A, B, C, R and S Path 4 where there are only two traces in the trace cache starting at address A, which are Path 1=A, B, C, D, E (trace start address A, trace number 0) and Path 2=A, B, C, M, N (trace start address A, trace number 1) and there are no traces existing in the trace cache starting at R. Again, a trace=A, B, C, R, S Path 4 (trace start address A, trace number 2) can be created according to the third exemplary condition because of the branch instruction at address C followed in sequence by the instruction at address R where no trace exists in the trace cache starting at address R.

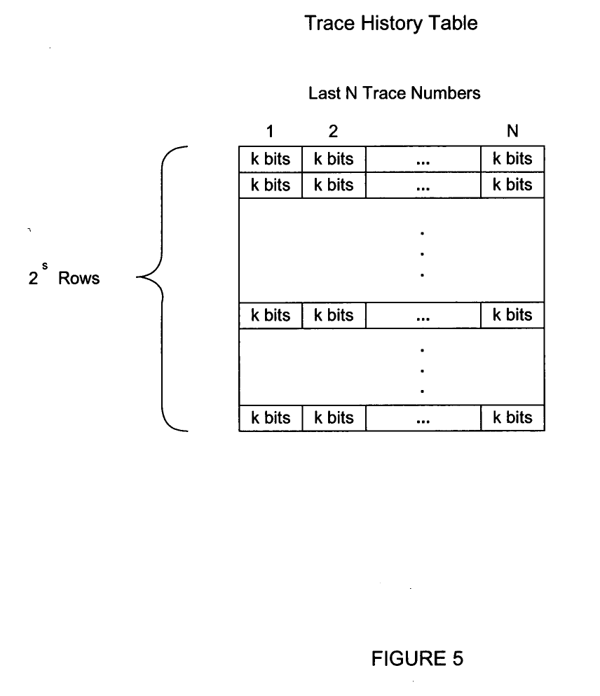

FIG. 5 illustrates a trace history table (THT) according to an exemplary embodiment of the present invention. Each row of the THT records the last N trace numbers to execute. The trace numbers have k bits allowing trace number values of 0 to 2^{k}−1. Each of the 2^{s} rows in the THT corresponds to a particular combination of global branch history and a trace start address (instruction address beginning a trace). The global branch history is maintained in a branch history shift register (BHSR).

The number of bits, s, representing the number of 2^{s} rows in the THT when using the GSHARE algorithm is the greater of the number of bits in the trace start address and the number of bits of the BHSR. When using the GAS algorithm it is the number of bits in the trace start address plus the number of bits of the BHSR.

In another exemplary embodiment, a trace history shift register (THSR) is used instead of a BHSR. Where the BHSR records the history of branch target addresses, the THSR records the history of trace numbers executed.

The output of the THT for a particular global branch history and trace start address is input to a trace number predictor. The trace number predictor then indicates which trace number is likely to execute for this combination of trace start address and global branch history.

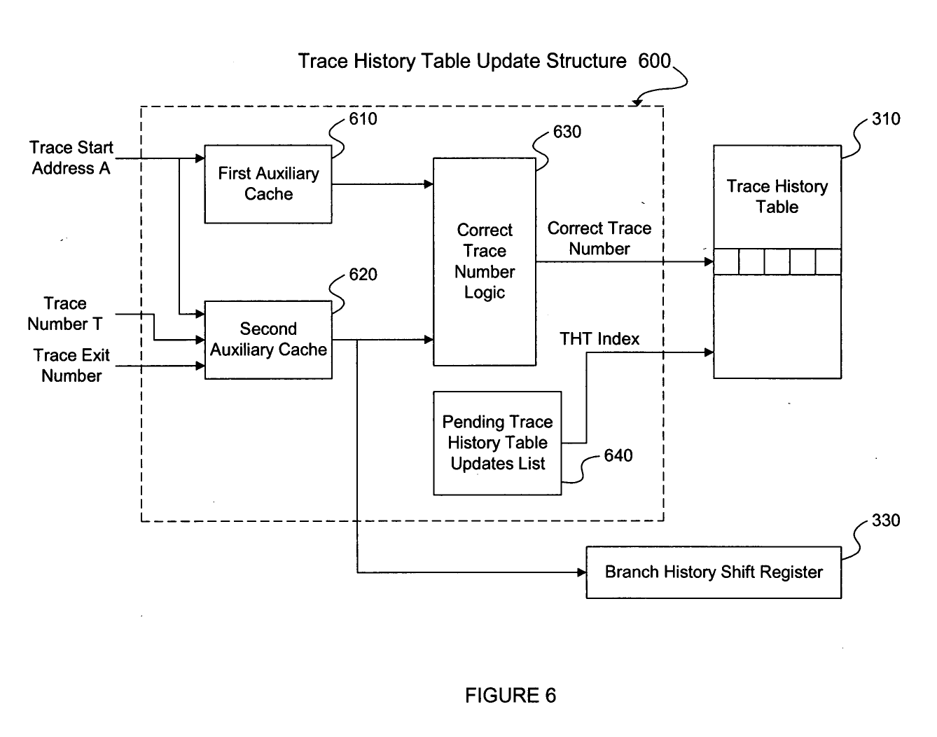

FIG. 6 is a block diagram of a trace history table update structure according to an exemplary embodiment of the present invention. To update the THT 310, the trace history table update structure 600 determines which trace, if any, starting at a particular trace start address was correct. The trace history table update structure 600 includes a first auxiliary cache 610, a second auxiliary cache 620, a correct trace number logic 630, and a pending trace history table updates list 640. The trace history table update structure 600 takes as inputs a trace start address, a trace number, and a trace exit number.

The trace start address is used to retrieve sequences of branch target addresses from the first auxiliary cache 610. The branch target address information can be the address at which program execution continues if a conditional branch is taken, a predetermined branch address caused by a non-conditional branch or the next sequential instruction if a branch is not taken. The first auxiliary cache 610 takes as an input the trace start address. As an output it provides up to 2^{k} sequences of branch target addresses, where there is one sequence for each trace in the trace cache beginning at a trace start address. In other embodiments the BHSR can simply record whether the branch was taken or not taken.

The trace start address, the trace number and the trace exit number are used to retrieve the actual branch target addresses from the second auxiliary cache 620. The second auxiliary cache 620 takes the trace start address as an input and takes the trace number of the trace that was predicted to execute and the exit number indicating at which branch the trace exited. Given these three inputs the second auxiliary cache 620 provides as an output the actual correct sequence of branch target addresses.

The correct trace number logic 630 uses the sequences of branch target addresses from the first auxiliary cache 610 and the actual correct branch target address from the second auxiliary cache 620 to access the correct trace number from the correct trace number logic 630. The correct trace number logic 630 compares the actual correct branch target address from the second auxiliary cache 620 to the up to 2^{k} branch target address sequences output from the first auxiliary cache 610, which represent the branch target addresses of the traces in the trace cache 220. Optionally, the branch target addresses from the first auxiliary cache 610 and the second auxiliary cache 620 can contain a subset of the trace start address bits, which reduces the size and the power consumption of the first auxiliary cache 610 and the second auxiliary cache 620. If a subset of bits is kept, two trace start addresses may be treated as equal when they are in fact not and some traces may be recorded as correct when they are not. However, this does not affect the correct execution of the computer, it only reduces the accuracy of the predictions made about which trace will execute.

If any of the sequences from the first auxiliary cache 610 matches the sequence from the second auxiliary cache 620, the THT 310 is updated with the trace number of the correct trace corresponding to this sequence. If none of the traces in the trace cache 220 match the correct sequence from the second auxiliary cache 620, then a special no-match value is placed in the THT 310.

The pending THT updates list 640 is used to determine the location in the THT 310 that should be updated with the correct trace number or a special no-match value. A particular row in the THT 310 is chosen based on the trace start address and the global branch history from the BHSR 330. The pending THT updates list 640 records this row information as each prediction is made. When the correct trace number beginning at the trace start address is eventually determined, the pending THT updates list 640 is consulted to determine which row in the THT 310 should be updated with the correct trace number. The correct trace number and a THT index supplied by the pending THT updates list 640 are provided to the THT 310 to update a THT entry. A variety of mechanisms can be used to track which entry in the chosen row of the THT 310 should be updated. For example, each row can be a shift register, which is shifted one entry to the right as each new entry is shifted into the row. Alternatively, each row can be maintained as a circular buffer with a pointer updated as each new entry is placed into the row.

When a trace is predicted to execute, the value of the trace number is entered into the appropriate entry of the THT 310. If neither the trace number nor any of the other traces starting at the same instruction address as the trace number correspond to the correct execution, the predicted but incorrect value of the trace number is left in the THT 310.

In some cases the correct trace number is not entered into the THT 310 where the appropriate THT entry can be set to a special no-match value or it can be set to the value of the trace predicted to execute.

The actual branch target address information from the second auxiliary cache 620 is used to update the BHSR 330 or the optional THSR (not shown) in the trace predictor structure 300. The BHSR 330 can be updated with the same output of the second auxiliary cache 620 that is used to update the correct trace number logic 630, since both it and the BHSR 330 require the correct sequence of branch target addresses.

Multiple traces may need to go through the second auxiliary cache 620 to determine the correct trace number for a particular trace start address.

The following is an example of such a case:
1) Starting at trace start address A, trace number 2 is predicted to execute.
2) Trace number 1 corresponds to an execution in which the first branch after trace start address A is taken.
3) The prediction that trace number 1 should execute turns out to be incorrect where the first branch after trace start address A is not taken.
4) However, trace number 0 starting at trace start address A correctly corresponds to the first branch after trace start address A not being taken.
5) The branch target address of the first branch after trace start address A is instruction address B.
6) Since trace number 1 exited early and with a next trace start address of B, one of the traces (trace number 2) starting at trace start address B is predicted to execute.
7) The first branch after trace start address B in trace number 2 corresponds to the second branch after trace start address A in trace number 0.
8) The direction taken by this second branch in trace number 0 starting from trace start address A matches the actual direction during this execution as indicated by the eventual exit point of trace number 2 starting from trace start address B.
9) Trace number 0 is now complete.
10) Having compared the branch target addresses of trace number 0 to the actual set of branch target addresses taken during this execution, the correct trace number logic 630 determines that trace number 0 is correct and puts the result in the appropriate location of the THT 310.
11) This comparison required that two traces, trace number 1 beginning at trace start address A and trace number 2 beginning at trace start address B be provided to the second auxiliary cache 620.

It is to be understood that embodiments of the present invention can be implemented in various forms of hardware, software, firmware, special purpose processes, micro instruction code or a combination thereof at the option of the computer system designer.

While the present invention has been particularly shown and described with reference to exemplary embodiments thereof, it will be understood by those skilled in the art that various changes in form and details may be made therein without departing from the spirit and scope of the present invention as defined by the claims. For example, the internal configuration of the system may be changed, or the internal devices of the system may be replaced with other equivalent devices. Accordingly, these and other changes and modifications are seen to be within the true spirit and scope of the invention as defined by the claims.

What is claimed is:

1. A trace cache system, comprising:
a trace start address cache for storing trace start addresses with successor trace start addresses;
a trace cache for storing traces of instructions executed;
a trace history table (THT) for storing trace numbers in rows;
a branch history shift register (BHSR) or a trace history shift register (THSR) that stores histories of branches or traces executed, respectively;
a THT row selector for selecting a trace number row from the THT, the selection derived from a combination of a trace start address and history information from the BHSR or the THSR; and
a trace number selector for selecting a trace number from the selected trace number row and for outputting the selected trace number as a predicted trace number.

2. The trace cache system according to claim 1, wherein the BHSR stores global histories of branches executed.

3. The trace cache system according to claim 1, wherein the histories of branches executed is comprised of branch target addresses or of branches taken or not taken.

4. The trace cache system according to claim 1, wherein the combination of a trace start address and information from the BHSR or the THSR is derived using a GSHARE or a GAS algorithm.

5. The trace cache system according to claim 1, wherein the trace number selector selects the most recently occurring trace number of the most frequently occurring trace number(s) from the selected trace number row.

6. The trace cache system according to claim 5, wherein the trace number selector selects the most recently occurring trace number of trace numbers occurring a predetermined number of times if any trace number(s) occur(s) the predetermined number of times.

7. The trace cache system according to claim 1, further comprising a THT update structure comprising:
a first auxiliary cache to store and retrieve sequences of branch target addresses derived from the trace start address;
a second auxiliary cache to store and retrieve the actual branch target address derived from the trace start address, a trace number and a trace exit number;
a correct trace number logic to access a correct trace number derived from the sequences of branch target addresses and the actual branch target address, to update the THT with the trace number of the correct trace number corresponding to this sequence if any of the sequences of branch target addresses match the sequence of the actual branch target address, and to place a special no-match value in the THT if none of the sequences of branch target addresses match the correct sequence of the actual branch target address; and
a pending THT updates list to generate a THT index derived from the trace start address and either branch history from the BHSR or trace history from the THSR, indicating a location in the THT that should be updated with the correct trace number or the special no-match value.

8. The trace cache system according to claim 7, wherein the branch target addresses from the first auxiliary cache and the actual branch target address from the second auxiliary cache contain a subset of the trace start address bits.

9. The trace cache system according to claim 7, wherein the BHSR or the THSR is updated from the actual branch target address.

10. The trace cache system according to claim 7, wherein the pending THT updates list comprises rows of shift registers or circular buffers.

11. A method of trace prediction for a multipath trace cache system comprising the steps of:
selecting a trace number row from a trace history table (THT), the selection derived from a combination of a trace start address and history information from a branch history shift register (BHSR) or a trace history shift register (THSR);
selecting a trace number from the selected trace number row; and
outputting the selected trace number as a predicted trace number.

12. The method of trace prediction according to claim 11, wherein the step of selecting a trace number row from a trace history table (THT) utilizes a GSHARE or a GAS algorithm to combine the trace start address with the history information from the BHSR or the THSR.

13. The method of trace prediction according to claim 11, wherein the step of selecting a trace number from the selected trace number row utilizes a trace prediction algorithm that selects the most recently occurring trace number of the most frequently occurring trace number(s) from the selected trace number row.

14. The method of trace prediction according to claim 13, wherein the step of selecting a trace number from the selected trace number row utilizes a trace prediction algorithm that selects the most recently occurring trace number of trace numbers occurring a predetermined number of times, if any trace number(s) occur(s) the predetermined number of times.

15. The method of trace prediction according to claim 11, further comprising the steps of:
retrieving sequences of branch target addresses based on a trace start address;
retrieving an actual branch target address based on the trace start address, a trace number and a trace exit number;
outputting a correct sequence of branch target addresses;
accessing a correct trace number in the THT using the sequences of branch target addresses and the actual branch target address;
comparing the actual branch target address with the branch target address sequences; and
updating the THT with the trace number of the correct trace number if any of the sequences of branch target addresses match the sequences of actual correct branch target addresses or placing a special no-match value in the THT if none of the sequences of branch target addresses match the correct branch target addresses.

16. The method of trace prediction according to claim 11, further comprising the steps of:
generating an index to a row of the THT derived from the trace start address and the global branch history or the trace number history;
recording the index information in the pending THT updates list as trace predictions are made; and
using the index information to update the THT with the correct trace number after a correct trace number beginning at the trace start address is determined or a special no-match value if no correct trace number is determined.

17. The method of trace prediction according to claim 11, further comprising the step of updating the BHSR or the THSR using actual branch target address information or actual trace number information, respectively.
